(19) United States
(12) Patent Application Publication
(10) Pub. No.: US 2013/0068325 A1
(43) Pub. Date: Mar. 21, 2013

(54) VALVE, LAYER STRUCTURE COMPRISING A FIRST AND A SECOND VALVE, MICROPUMP AND METHOD OF PRODUCING A VALVE

(71) Applicants: Markus Herz, (US); Martin Richter, Muenchen (DE); Martin Wackerle, Muenchen (DE)

(72) Inventors: Markus Herz, (US); Martin Richter, Muenchen (DE); Martin Wackerle, Muenchen (DE)

(21) Appl. No.: 13/604,262

(22) Filed: Sep. 5, 2012

Related U.S. Application Data
(63) Continuation of application No. PCT/EP2010/052842, filed on Mar. 5, 2010.

(51) Int. Cl. F16K 1/42; B21D 51/16

(52) U.S. Cl. 137/565.01; 251/359; 29/890.12

(57) ABSTRACT

A valve, including a valve opening and a valve plate arranged to seal the valve opening in a closed state by means of compressing a sealing structure is provided, wherein the sealing structure includes an uncompressed dimension in a compression direction of less than 100 μm.

### CROSS-REFERENCE TO RELATED APPLICATIONS

This application is a continuation of copending International Application No. PCT/EP2010/052842, filed Mar. 5, 2010, which is incorporated herein by reference in its entirety.

### BACKGROUND OF THE INVENTION

The present invention relates to valves, layer structures and micropumps comprising such valves and methods for producing such valves.

One known technology for producing passive micro check valves is to structure silicon substrates to define a valve seat and a valve flap of a passive micro check valve. Other known technologies for producing micro check valves comprise structuring metal foils or polymeric foils to define channel and flap structures for micro check valves.

Brian K. Paul and Tyson Terhaar describe in “Comparison of Two Passive Microvalve Designs for Microlamination Architectures”, J. Micromech. Microeng. 10 (2000), pages 15 to 20, a microflapper valve. The microflapper valve design consists of two laminae that are bonded together. One of the laminae contains the valve seat, whereas the other contains the flapper mechanism. A polyimide resist is applied either to the back of the flapper or to the valve seat as sealing.

Ming Yang et al. describe in “Development of Micro Metallic Valve for μTAS”, Journal of Solid Mechanics and Material Engineering, 3, 729-739, 2009, a micropump and a micro metallic valve made of thin metal foils, for example, stainless steel or titanium alloys. In order to compensate the roughness of the surfaces of the metal foils, soft type and hard type gold plating is used. In addition, the surfaces are functionalized to improve the behavior of the valve.

Nam-Trung Nguyen et al. describe in “A Fully Polymeric Micropump with Piezoelectric Actuator” in Sensors and Actuators B 97 (2004), pages 137-143, a polymeric micropump built by using a stack of structured polymeric plates and a piezodisc working as both an actuator and a pump membrane. As valves, orthoplanar spring elements are used.

Conventional sealings for such micro valves necessitate large movements between an open state and a closed state and/or high closing pressures to achieve reliable sealing characteristics.

### SUMMARY

According to an embodiment, a valve may have: a valve opening; and a valve plate arranged to seal the valve opening in a closed state by means of compressing a sealing structure, wherein the sealing structure has an uncompressed dimension in a compression direction of less than 100 μm.

Another embodiment may have a micro pump including a first valve and/or a second valve according to the invention.

Another embodiment may have a layer structure including a first layer arranged above a second layer and a first valve and a second valve according to the invention, wherein the valve plate of the first valve and the valve opening of the second micro valve are formed in the first layer and the valve opening of the first valve and the valve plate of the second valve are formed in the second layer.

According to another embodiment, a micro pump may have: an inventive layer structure; a pump membrane connected to the first layer so as to define a pump chamber, wherein the pump membrane is pre-bulged; and a drive means adapted to move the pump membrane towards the first layer when the drive means is activated.

According to another embodiment, a method of producing a valve, the valve including a valve opening and a valve plate arranged to seal the valve opening in a closed state by means of compressing a sealing structure, may have the step of: producing the sealing structure with an uncompressed dimension in a compression direction of less than 100 μm.

According to an embodiment, a valve is provided, the valve including a valve opening and a valve plate arranged to seal the valve opening in a closed state by means of compressing a sealing structure, wherein the sealing structure has an uncompressed dimension or uncompressed height in a compression direction of less than 100 μm.

In many applications valves that completely seal in a closed state of the valve are advantageous or even mandatory, like for example, in medical applications or fuel cell applications.

Valves, and in particular micro valves, with hard-hard sealings, for example, between a metal valve plate and a metal valve seat, typically do not fulfill these requirements due to the roughness of the metal or its unevenness. Therefore, hard-soft sealings, for example an elastic sealing structure between the metal valve plate and the metal valve seat, are implemented to seal the valve completely by compressing the elastic sealing structure.

The present invention is based on the finding that reducing the uncompressed dimension of the sealing structure in the compression direction below 100 μm also reduces the necessitated valve stroke, i.e. the distance the valve plate has to be moved in compression direction between an open state with a predetermined flow cross-section and a closed state with predetermined sealing characteristics, and vice versa. Conventional soft sealings have, for example, uncompressed dimensions in the compression direction of 300 μm and necessitate a compression of the sealing structure in compression direction by 10%-20% of the uncompressed dimension, i.e. by 30 μm-60 μm, to completely seal the valve. The corresponding stroke of the valve plate is, thus, even larger than these 30 μm-60 μm because the valve plate not only has to compress the sealing structure to the compressed dimension of 90%-80% of the uncompressed dimension but also has to even move further to provide a predetermined opening and flow cross section in the open state. Embodiments of the present invention comprise sealing structures with uncompressed dimensions in the compression direction of less than 100 μm, and thus, only necessitate for example a compression by 10 μm (for 10% compression) or 20 μm (for 20% compression), wherein a compression by 10% or more is typically sufficient to provide a reliable sealing.

The present invention is based on the further finding that piezo actuators, even as membrane transducers or as piezo stacks, typically only have a technically usable stroke of some μm to some 10 μm. Therefore, conventional hard-soft-sealings with uncompressed dimensions of 300 μm cannot be driven (opened and closed) by piezo actuators. On the other hand, piezo actuators with hard-hard-sealings do not provide sufficient sealing. To implement active piezo valves with soft-sealing or hard-soft-sealing, the uncompressed dimension of the sealing structure and also the valve stroke resulting therefore may not be too large, or in other words, should be as small as possible. The same applies, for example, for peristaltic micro pumps with active valves. By providing a sealing structure with an uncompressed dimension as small as possible, for example, on a valve seat or the membrane arranged opposite to the valve seat, it is possible that the piezo actuator can open and reliably close the valve. In other words, embodiments of the present invention finally allow to provide completely sealing active valves actuated by piezo drive means or similar drive means with small strokes.

Embodiments of the valve comprise sealing structures with uncompressed dimensions in the compression direction of less than 60 μm or even less than 40 μm.

Embodiments of the present invention further reduce the dead volume of the valves compared to conventional soft sealings due to the reduced dimension of the sealing structure in compression direction.

In addition, embodiments also allow reduce the dimension of the complete valve due to the reduced dimension of the sealing structure in compression direction. In particular, embodiments, wherein both the valve plate and the valve opening are formed in thin layers or foils arranged on top of each other, the reduction of the dimension of the sealing structure in compression direction facilitates to reduce the height of the layer structure comprising the valve.

Embodiments of the valve can comprise passive and active valves, normally open and normally closed valves, and in particular active micro valves with drive means, for example piezo drive means, to open and close the active micro valve, passive micro valves, for example passive micro check valves, and normally open or normally closed micro valves.

Embodiments of the valve can, for example, be produced by creating the sealing structure using spraying processes or spin-coating processes that allow to create sealing structures with a height of less than 100 μm in an uncompressed state. In combination with the use of elastic and highly-elastic sealing materials, for example, polymers, like silicone or caoutchouc, the sealing characteristics of the micro check valves can, thus, be further improved.

The application of thin sealing structures with a height of less than 100 μm in an uncompressed state and sufficient elasticity or a sufficiently low Young's modulus decreases the extent to which the spring elements are deflected in a closed state of the valve and, thus, reduces the material fatigue and the fatigue of the restoring force of the spring element.

Furthermore, embodiments may—due to the lower height in the uncompressed state—comprise spring elements with lower restoring forces or less pre-stressed spring elements and still may provide similar sealing characteristics as conventional hard/soft sealings with higher or thicker sealing arrangements.

On the other hand, embodiments of the valve with pre-stressed spring elements having restoring forces comparable to the spring elements in conventional micro check valves can provide improved sealing characteristics as they compress the sealing structure by more than 10% or 20% compared to the sealing structure's uncompressed height.

Furthermore, as the distance the valve plate has to be moved between the closed state of the valve (i.e. the state in which the sealing structure is compressed to the compressed dimension or height) and an open state (i.e. the state in which the sealing structure has at least partially—e.g. on the side opposite to a spring element—lost contact to the valve plate such that a gap between the sealing structure and the valve plate for a fluid flow is created) is smaller than in conventional hard/soft sealings, embodiments of the microvalve provide faster response times and shorter opening/closing cycles.

With regard to embodiments of micro check flap valves comprising one or several spring elements, e.g. on only one side of the valve plate, the sealing characteristic and sealing reliability is improved compared to conventional soft sealings due to the reduced deflection of the spring element or spring elements of the flap valve.

Compared to valve designs based on semiconductor materials and production processes (including embodiments of the valve comprising semiconductor materials), embodiments of the valve and of the method for producing same based on metal or metal layer structures have cost advantages with regard to the material and the production processes, because metal foils with a height or thickness of less than 500 μm can be provided at comparable low costs and also the structuring of such metal foils or layers for forming the holes, plate structures or other structures can be cost-efficiently performed using laser ablation or etching processes. In addition, metal layers can comprise lower Young's moduli compared to semiconductor layers and, thus, can be operated, for example, at lower piezo driving voltages and/or can combine high frequency switching characteristics (switching between closed and opened states) with closed states with minimum or no leakage and open states with high cross-sectional areas in the open state.

Similar considerations apply to embodiments based on synthetic materials.

### BRIEF DESCRIPTION OF THE DRAWINGS

Embodiments of the present invention will be detailed subsequently referring to the appended drawings, in which:

FIG. 1A shows a top view of a first embodiment of the micro check valve formed by a stack of two structured metal layers;

FIG. 1B shows a cross-sectional view of the lower metal layer of the first embodiment according to FIG. 1a in an uncompressed state prior to the connection of the first metal layer on top of the second metal layer;

FIG. 1C shows a cross-sectional view of the first embodiment of the micro check valve according to FIG. 1a in a closed state, i.e. the sealing structure in a compressed state;

FIG. 2 shows an exploded view of a layer structure comprising a first and a second passive micro check valve with opposite flow directions; and

FIG. 3 shows an exploded view of an embodiment of a micropump comprising a further layer structure with a first and a second passive micro check valve with opposite flow directions;

FIG. 4 shows a schematic drawing of an embodiment of a normally closed valve with soft sealing;

FIG. 5A,B show cross sections of peristaltic micro pumps comprising active valves with soft sealing;

FIG. 6 shows a cross section of a silicon peristaltic pump with soft sealing;

FIG. 7A,B show cross sections of active normally open valves with a soft sealing;

FIG. 8 shows a cross section of a normally open active valve with a pre-bulged valve membrane.

Equal or equivalent elements are denoted in the following description of the Figs. by equal or equivalent reference numerals.

### DETAILED DESCRIPTION OF THE INVENTION

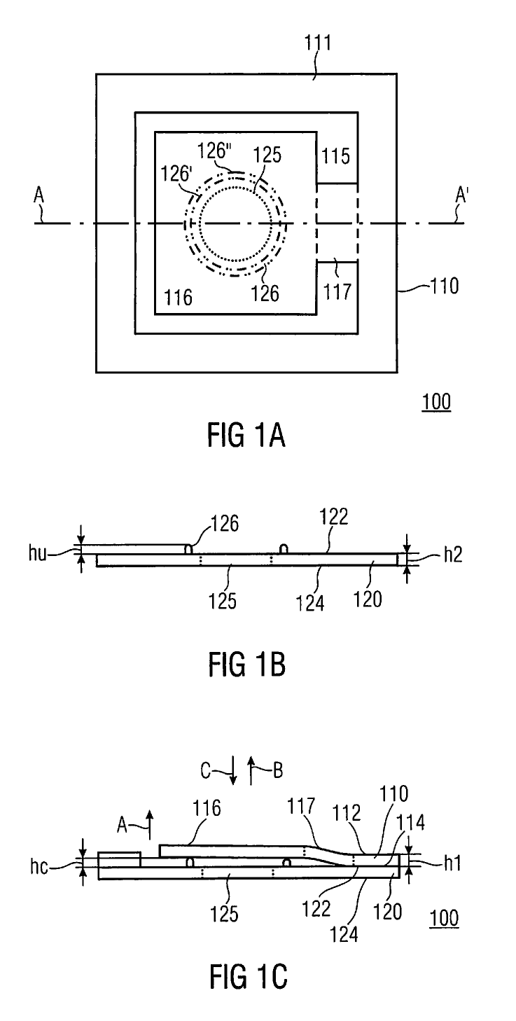

In the following a first embodiment of a passive micro check valve, also referred to as “micro check valve” or “valve”, will be described based on FIGS. 1A to 1C. The valve opening is also referred to as hole or valve hole, the uncompressed dimension in compression direction is also referred to as uncompressed height and the compressed dimension in compression direction is also referred to as compressed height.

FIG. 1A shows a top view of the embodiment of a passive micro check valve 100 comprising a first metal layer 110 arranged on top of a second metal layer 120. The first metal layer 110 comprises a first surface 112 and a second surface 113 arranged opposite to the first surface. The second metal layer 120 comprises a first surface 122 and a second surface 124 opposite to the first surface 122 of the second metal layer 120. With regard to the orientation of FIG. 1C, the first surface 112 of the first metal layer 110 and the first surface 122 of the second metal layer 120 can also be referred to as the upper layer 112, respectively, 124 and the second surface 114 of the first metal layer 110 and the second surface 124 of the second metal layer 120 can also be referred to as the bottom surface or the lower surface 114 and 124. The first metal layer 110 further comprises a frame section 111, a cavity 125 extending from the first surface 112 to the second surface 114 of the first metal layer, the cavity 115 defining the valve plate 116, also referred to as plate 116, and a spring element 117 connecting the plate 116 in a deflectable manner with the frame 111 of the first metal layer 110. Although not visible within the top view, FIG. 1A additionally shows a hole 125 arranged in the second metal layer 120, the inner border 126′ and the outer border 126″ (see the double-dotted line in FIG. 1A) of the sealing structure 126 that is arranged around the hole 125 and on the first surface 122 of the second metal layer 120. As can be seen from FIGS. 1A and 1C, the first structured metal layer 110 forms the valve, whereas the second structured metal layer 120 forms the valve's seat including the valve inlet (hole 125). Accordingly, the dimensions and the positions of the plate 116 with regard to the hole 125 and the sealing structure 126 is such that in a closed state of the valve, the plate fully covers the area defined by the sealing structure 126 or at least defined by the inner border 126′ of the sealing structure 126. In other words, the valve 116 is arranged above and opposite to the hole 125 and the sealing structure 126 and extends beyond the dimensions of the sealing structure 126.

The first and second metal layer can also be referred to as first and second structured metal layer as they comprise structures like the cavity 115 or the hole 125 to define the valve. These structures can, e.g., be produced by laser ablation or etching to form, e.g. the valve including the frame, the plate and the spring element from one single metal layer 110 and to form the valve seat including the hole (valve inlet) from a single further metal layer 120. The first and second metal layer can each also be formed by stacks of, e.g. different, bonded metals comprising the respective structures.

FIG. 1B shows a cross-sectional view of the second metal layer 120 without the first metal layer, for example, before the first metal layer 110 is connected or bonded to the second metal layer 120. The sealing structure 126 is, therefore, in an uncompressed state and has an uncompressed height hu, as shown in FIG. 1B of less than 100 μm. In further embodiments, the uncompressed height hu can be less than 60 μm, less than 40 μm or less than 20 μm. The height h2 of the second metal layer 120 lies within a range of 5 μm to 100 μm and in further embodiments in a range between 5 μm to 15 μm.

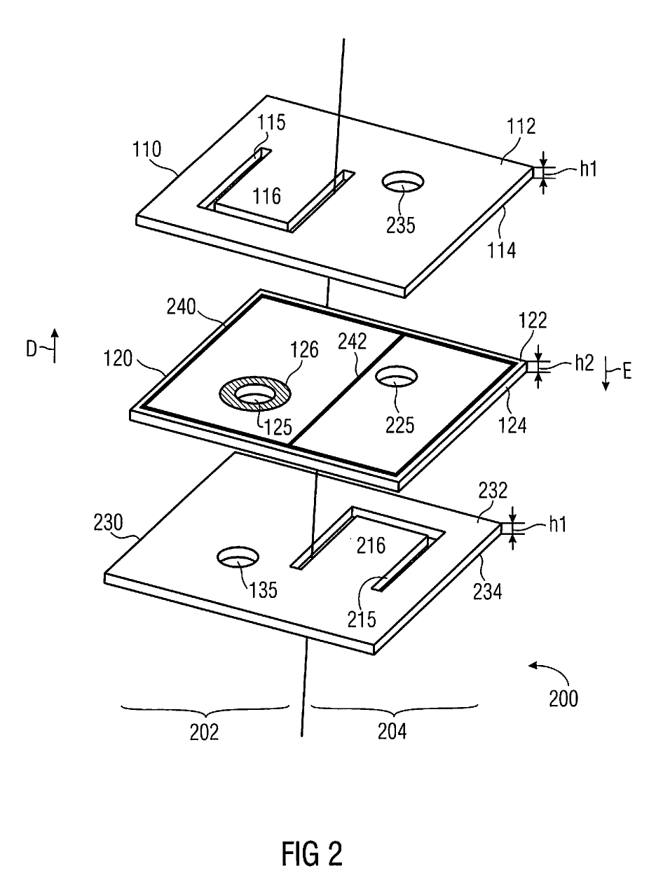

FIG. 1C shows a cross-sectional view of cross-section A-A′ of FIG. 1A in a closed state. When no external pressure is applied to the valve, the spring element 117 in combination with the plate 116 (for simplicity reasons in the following also referred to as plate structure 116, 117 or just plate 116 as the spring element can also be integrally formed with the plate 116, see e.g. FIG. 2), presses the sealing structure 126 downwards, i.e. in the direction of or towards the second metal plate 120. In other words, the plate structure including the spring element 117 compresses the sealing structure 126 to a compressed height hc. The compressed height of the sealing structure is less than 90% of the uncompressed height hu or, in other words, less than 90 μm in case the uncompressed height is less than 100 μm. As can be seen from FIG. 1C, the plate structure 116, 117 is slightly deflected away from the second metal layer 120 due to the sealing structure 126.

As can be seen from FIG. 1C, the plate structure 116, 117 can essentially only move—starting from the compressed state of the sealing structure (i.e. the closed state of the valve 100)—in one direction (see arrow A), i.e. away from the first and second metal layers and again back to the closed state. In other words, the flow direction of the valve 100 (see arrow B) is defined as the direction from the second metal layer 122 to the first metal layer 110 and the blocking direction (see arrow C) is defined as the direction from the first metal layer 110 to the second metal layer 120. The pressure in flow direction can, for example, be generated by applying a negative pressure on the side of the first metal layer 110 or by applying a positive pressure on the side of the second metal layer 120. The pressure at which the valve 100 opens depends on the pressure difference between the pressure on the side of the second metal layer 120 and the pressure on the side of the first metal layer 110 and the spring stiffness of the spring element 117 and the corresponding reposition force caused by the spring element 117. In case the pressure difference exceeds a certain pressure threshold, the plate structure 116, 117 will be deflected to such an extent that the valve plate structure looses contact with the sealing structure 126 and, thus, the valve 100 opens.

If a positive pressure is applied from the side of the first metal layer 110 or, in other words, a positive pressure difference between the side of the first metal layer and the second metal layer as applied, the plate structure 116, 117 is further pressed in a direction towards the second metal layer 120 and compresses the sealing structure even more and below the compressed height hc.

Irrespective of whether a pressure in blocking direction C is applied, no pressure or a pressure in flow direction (in flow direction, however, below the threshold pressure) is applied, the sealing structure 126 prevents, or at least reduces, leakage due to the high surface roughness of the metal layers compared, for example, to semiconductor surfaces. The softer the sealing material of the sealing structure or, in other words, the lower the Young's modulus of the sealing material, the lower is the necessitated repositioning force or the lower the spring stiffness necessitated to compress the sealing material and to, thus, close the valve 100.

Therefore, sealing materials may, for example, be any non-metallic sealing materials, polymers and, in particular, elastic or soft polymers, like silicone and natural or synthetic caoutchouc. In further embodiments, also polyterafluorethylen (PTFE) may be used due to its high chemical durability for special applications.

In further embodiments, the hard/soft sealing provided by the hard metal plate 116 and the soft sealing structure 126 can be adapted such that the compressed height hc is less than 90% or less than 80% of the uncompressed height hu, for example, by using a very soft sealing material, i.e. sealing materials with very low Young's moduli, like silicone or caoutchouc and/or by increasing the pre-stressing of the spring element 117, respectively, the plate structure 116, 117 and/or by using metals with high stiffness values, like stainless steel and even spring stainless steel for the first metal layer 110 or for the first and the second metal layer.

In further embodiments, the second metal layer 120 can comprise a stopping means or a stopper arranged for stopping a deflection of the plate 216 towards the second metal layer 120, wherein the stopping means is arranged on the first surface 122 of the second metal layer is integrated in and surrounded by the elastic sealing structure 126. The stopper is stiffer, i.e. has a higher Young's modulus than the sealing material and has a height of less than 70% of the sealing structure in the uncompressed state if the compressed height is, e.g., less than 90%, and has a height less than 60% if the compressed height hc is less than 80% or has a height of less than 50% if the compressed height hc is less than 70%. The stopper protects, for example, the sealing structure 126 in case of high pressures in the blocking direction, which might otherwise damage the sealing structure permanently.

In further embodiments, the plate 116 can comprise a second sealing structure on the second surface 114, i.e. the surface opposite to or facing towards the second metal layer to provide a soft-sealing. The second sealing structure may comprise the same sealing material as the sealing structure 126 or may include different sealing materials. Furthermore, the second sealing structure may have a geometric lateral form, like the sealing structure 116 or may be formed as a continuous layer of sealing material covering parts or the complete second surface of plate 116.

The first metal layer 110 and the second metal layer 120 can, for example, be connected to each other by laser bonding, for example, in the frame section 111.

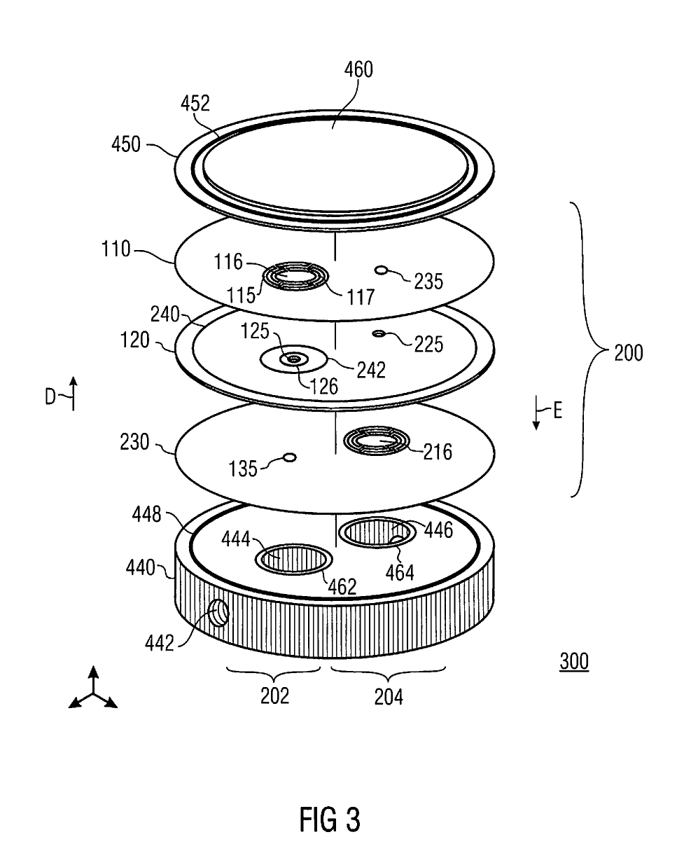

Although FIGS. 1A to 1C show a plate structure 116, 117 comprising a valve plate 116 and a dedicated spring element 117, other embodiments of the micro check valve may comprise flap valves that do not comprise separately structured spring elements 117, but a combined or integrated plate and spring element (see, for example, FIG. 2). In further embodiments, the plate structure may comprise more than one spring element 117, for example, for folded springs to form an orthoplanar valve (see, for example, FIG. 3).

FIG. 2 shows an exploded view of an embodiment of a layer structure 200 comprising a first and a second passive micro check valve with opposite flow directions. As can be seen from FIG. 2, the layer structure comprises a first metal layer 110 arranged on top of a second metal layer 120, the latter, again, arranged on top of a third metal layer 230. The structured first metal layer 110, the second structured metal layer 120 and the third structured metal layer 230 form a first passive micro check valve 202 (left-hand side of the metal layers in FIG. 2) with a first flow direction (upwards, see arrow D in FIG. 2) and a second micro check valve 204 (right-hand side of the metal layers in FIG. 2) with a second, opposite flow direction (downwards according to FIG. 2, see arrow E).

The first metal layer 110 comprises a first or upper surface 112 and a lower or second surface 114 arranged opposite to the first surface 112. The second metal layer 120 comprises a first or upper surface 122 and a second or lower surface 124 arranged opposite to the first layer 122. The third metal layer 230 comprises a first or upper surface 232 and a second or lower surface 234 arranged opposite to the first surface 232. The first metal layer 110 is structured via a cavity or recession 115 extending from the first surface 112 to the second surface 114 of the first metal layer such that the plate 116 of the first micro check valve 202 is formed within the first metal layer, wherein the plate 116 is connected to the first metal layer in a deflectable manner. As can be seen from FIG. 2, the spring element (no reference sign in FIG. 2) of the first micro check valve is integrally formed with the plate 116 and has the same lateral width as the plate 116 itself. The first metal layer 110 further comprises a hole 235 extending from the first surface 112 to the second surface 114 spaced laterally apart from the plate structure 116. The second metal layer 120 comprises a first hole 125 extending from the first surface 122 to the second surface 124 of the second metal layer 120. The sealing structure 126 is arranged around the first hole 125 and on the first surface 122 of the second metal layer that is arranged opposite to the first metal layer or, in other words, arranged facing towards the first metal layer 110 (whereas the first surface 122 faces towards the first metal layer 110). The second metal layer 120 further comprises a second hole 225 spaced laterally apart from the first hole 125, the second hole 225 extending from the first surface 122 to the second surface 124 of the metal layer 120. The third metal layer 230 comprises a hole 135 extending from the first surface 232 to the second surface 234 of the third metal layer 230. The third metal layer 230 is structured—via a cavity or recession 215 extending from the first surface 232 to the second surface 234 of the third metal layer—such that a plate 216 of the second passive micro check valve is formed within the third metal layer that is connected to the third metal layer in a deflectable manner. As for the plate structure 116 of the first micro check valve in the first metal layer 110, the plate structure 216 comprises an integrally-formed spring element that connects the plate section of the plate structure with the third metal layer 230 in a deflectable or bendable manner.

The hole 135 of the third metal layer and the first hole 125 of the second metal layer 120 are arranged such in the third and correspondingly second metal layers that they form a valve inlet of the first micro check valve 202, wherein the sealing structure 126 and the plate 116 form a hard/soft sealing of the first micro check valve 202.

The hole 235 of the first metal layer and the second hole 225 of the second metal layer 120 are arranged (i.e. are positioned on the first and second metal layers and dimensioned) such that they form a valve inlet of the second micro check valve 204. The second metal layer 120 comprises a second sealing structure (not shown in FIG. 2) that is arranged on the second surface 124 and around the second hole 225 to provide a hard/soft sealing of the second passive micro check valve 204 formed by the second sealing structure and the plate 216 of the third metal layer. The first metal layer 110 is connected to the second metal layer 120, e.g. by laser welding or laser bonding. The laser-welding connection line 240 is arranged such that it surrounds the area defined by the recession 115 in the first metal layer 110 and the hole 125 and the second metal layer on the one hand and, on the other hand, the area or section defined by the hole 235 in the first metal layer and the second hole 225 in the second metal layer to seal or completely fluidly disconnect the space between the first metal layer 110 and the second metal layer 120 from the environment. The laser-welding connection line 240 can be further arranged such that a section 242 of the laser-welding connection line fluidly disconnects the first hole 125 and the plate structure 116 of the first metal layer (both forming or forming at least a part of the first passive micro check valve 202) from the hole 235 within the first metal layer 110 and the second hole 225 within the second metal layer 120 (both forming the inlet of the second passive micro check valve 204). The second metal layer 120 and the third metal layer 230 are mechanically connected to each other via a further laser-welding or laser bonding connection line (not shown) connecting the second surface 124 of the second metal layer 120 and the first surface 232 of the third metal layer 230 in a corresponding manner as described for the laser-welding connection between the first metal layer 110 and the second metal layer 120 to fluidly disconnect the first and second valve and each of the valves from the circumference or environment. Both laser-welding connections can be produced at the same time and, for example, can have the same route, i.e. the same lateral position with regard to the metal layers.

Therefore, as can be seen from FIG. 2, the first metal layer and the third metal layer can be identical so that only one design is necessitated for the production of the first and the second metal layers.

The height h1 of the first metal layer 110 and of the third metal layer 230 may lie within a range of 5 μm to 100 μm or in a range between 10 μm to 50 μm. The height h2 of the second or central metal layer 120 may lie within a range of 50 μm to 500 μm or within a range of 100 μm to 300 μm. The second metal layer 120 can be thicker than the first and the third metal layer in order to provide improved mechanical stability of the layer structure 200.

In further embodiments, the layer structure may only comprise the first layer structure 110 and the third layer structure 230, i.e. no middle layer structure 120. In such embodiments, the first sealing structure 126 would be arranged on the first surface 232 of the lower layer structure 230 and the second sealing structure would be arranged on the second surface 114 of the upper layer structure 110. Furthermore, only one laser-welding connection structure 240, 242 would be necessitated to connect the upper metal layer 110 and the lower metal layer 230.

FIG. 3 shows an explosion view of an embodiment of the micropump 300 comprising a layer structure 200 similar to the one described based on FIG. 2. In contrast to the layer structure comprising the first passive micro check valve 202 and the second passive micro check valve 204 with opposite flow directions as described based on FIG. 2, the first, second and third metal layers 110, 120 and 230 have circular shapes (instead of the rectangular shapes of FIG. 2) and instead of the flap valves with one spring element or integrally-formed spring sections of the valve plates 116, 216, the two plate structures 116, 216 comprise planar plate structures suspended by four folded spring elements 117. The orthoplanar design facilitates that the valve plate 216 is displaced in parallel to the disc surface and, thus, allows for an improved sealing and flow performance or characteristic. Furthermore, instead of the laser-welding connection section 242 as shown in FIG. 2 extending from opposite sides of the metal layer to fluidly disconnect the first valve 202 from the second valve 204, the layer structure 200 comprises a laser-welding connection section 242 that is arranged around the sealing structure 126 to fluidly disconnect the first valve 202, respectively, flow D from the second valve 204, respectively, flow E. The second sealing structure (not shown) and a second circular laser-welding connection (arranged around the hole 225, not shown) are arranged on the second or lower surface of the second layer 240 to fluidly disconnect the second valve 204 or second flow (with direction E) from the first valve 202, respectively, first flow (with direction D) in the area between the second metal layer 120 and the third metal layer 230.

The layer structure 200 is arranged on top of a fourth layer structure 440 forming a base of the micropump and comprising an horizontal inlet hole 442 that is fluidly connected to a vertical inlet cavity 444 that is fluidly connected to the hole 135 within the third metal layer 230. In addition, the fourth metal layer 440 comprises a horizontal outlet hole (on the backside, not shown) that is connected to a vertical outlet section 446 that is, again, fluidly connected to the holes 225 and 235 within the first and second metal layers via the valve 216 within the third metal layer 230.

The micropump 300 further comprises a fifth metal layer 450 forming the membrane of the micropump. The membrane 450 and the first metal layer 110 are arranged such that they form the pump chamber, i.e. the pump chamber is the volume between the lower surface of the metal pump membrane 450 and the top surface 112 of the first metal layer 110. On top of the membrane 450, a driving means 460, for example, a piezo driving means 460, is arranged to move the membrane 450 between a first, for example, bulged position and a second position, for example, a less-bulged position. The pump membrane 460 increases the volume of the pump chamber by a stroke volume when moving from the second less-bulged position to the first bulged position and reduces the volume of the pump chamber by this stroke volume when moving from the first bulged position to the second less-bulged position. In other words, when moving from the second position to the first position, a negative pressure within the pump chamber is generated and when moving from the first position to the second position, a positive pressure is generated within the pump chamber. If the negative pressure (the pressure within the pump chamber is smaller than the pressure at the pump inlet area defined by the holes 125, 135 and the inlet section 444) exceeds a threshold pressure difference defined by the stiffness of the plate structure 116 (i.e. by the stiffness of the four spring elements of the orthoplanar valve 116), the valve plate 116 is moved towards the pump chamber (upwards with regard to FIG. 3) and the fluid is sucked into the pump chamber. On the other hand, if the positive pressure (the pressure within the pump chamber including the holes 235 and 225 is larger than the pressure at the pump outlet area defined by the outlet section 446) is larger than a second threshold pressure defined by the stiffness of the plate structure 216 (i.e. by the stiffness of the four spring elements of the orthoplanar valve 216), the valve plate 216 is moved towards the fourth plate 440 and fluid within the pump chamber 460 is pressed or pumped out to the outlet section 446. Embodiments of the micro check valve and of the micro pump comprising such micro check valves are capable of conveying gasses, liquids and/or liquids with gas bubbles or vice versa as fluids.

The first to fifth metal layers 110, 120, 230, 440 and 450 can all comprise metal or can be made of metals and, for example, can comprise the same metal or different metals as necessitated by the specific valve and/or pump application. The first metal layer 110, the third metal layer 230 and the membrane 450 comprise stainless steel or spring stainless steel as materials. In alternative embodiments one or all layers 110, 120, 230, 440 and 450 may comprise different materials than metal, for example, synthetic materials.

In FIG. 3, the membrane 450 is connected via a laser-welding or laser bonding connection 452 to the first metal layer 110 and the fourth metal layer 440 is connected via a further laser-welding connection 448 to the third metal layer 230. In addition, the micro pump 300 comprises a first laser-welding structure 462 surrounding the area defined by the hole 135 of the third metal layer and the inlet section 444 of the fourth metal layer and arranged between the third metal layer 230 and the fourth metal layer 440 to fluidly disconnect the inlet direction D from the outlet direction E. In further embodiments, the micropump 300 may comprise an additional laser-welding connection 464 surrounding the area defined by the valve 216 and the corresponding recessions and spring elements structured into the third metal layer 230 and the outlet section 446 within the fourth layer 414 and arranged between the third layer 230 and the fourth metal layer 440 to further improve the sealing characteristics of the outlet section 446 and to reduce dead volumes. In other words, the first to fifth metal layers of the embodiment of the micropump according to FIG. 3 can all be connected to each other via laser-welding and are also fluidly disconnected, where necessitated, by laser-welding. Thus, embodiments allow for an efficient and easy production engineering and production of micro check valves and micro pumps. Further embodiments may comprise different connection and sealing technologies, for example gluing.

In further embodiments of the micropump 300, the first metal layer 110 has a plane shape, or at least a first surface 112 with a plane shape, the less-bulged second position of the pump membrane 450 is an essentially planar position, i.e. a position in which the membrane 450 has also a planar shape (like the first metal layer) such that the remaining pump chamber volume, also referred to as a dead volume between the membrane 450 and the planar metal layer 110 is minimized and is essentially only defined by the cavities 115 of the first valve structure 116 in the first metal layer 110 and by the volume of the hole 235 in the first metal layer 110 and by the volume of the second hole 225 within the second metal layer. Such embodiments provide high compression ratios.

Certain embodiments of the micropump 300 can be arranged such that the pump membrane 450 is in the second less-bulged position, for example, the planar position, if the driving means is not actuated and is moved to the first bulged position if the driving means is actuated. In other embodiments, the pump membrane 450 can be pre-bulged such that the pump membrane 450 is in the first bulged position if the driving means is not actuated (inactive) and moved to the second less-bulged, position, for example, the planar position, if the driving means is actuated (activated).

Further embodiments of the present invention provide a method of producing a passive micro check valve according to FIGS. 1 to 3, the method comprising providing a first metal layer structured such that a plate of the micro check valve is formed within the first metal layer that is connected via a spring element to the first metal layer in a deflectable manner. The method further comprises providing a second metal layer, creating a hole in the second metal layer and creating an elastic sealing structure around the hole on the surface of the second metal layer that is to be arranged opposite to the first metal layer, wherein the sealing structure has an uncompressed height of less than 100 μm. The method finally comprises connecting the second metal layer to the first metal layer such that the hole forms an inlet of the micro check valve and the plate is arranged opposed to the hole, wherein the plate and the spring element are arranged such that the elastic sealing structure is compressed to a compressed height, the compressed height being less than, e.g., 40% of the uncompressed height, as described above.

Further embodiments of the method comprise providing the first metal layer and structuring the first metal layer such that the plate of the micro check valve is formed within the first metal layer that is connected via a spring element to the first metal layer in a deflectable manner.

The steps of providing the first metal layer and structuring the first metal layer and the steps of providing the second metal layer and creating the hole in the second metal layer can be performed sequentially or in parallel. Furthermore, the second metal layer can also be provided already comprising the hole and/or the step of creating the elastic sealing structure can be performed prior to creating the hole in the second metal layer. The metal layers can, e.g. due to their low height, also be referred to as metal membranes.

The step of creating the elastic sealing structure, for example, can be performed by providing a mask defining a lateral geometry of the sealing structure 126 (126′ and 126″) and spraying the sealing material onto the first surface 122 of the second metal layer 120 using the mask.

In further embodiments, the step of creating the elastic sealing structure comprises spin-coating the sealing material onto at least a part of the first surface 122 of the second metal layer 120 and locally or structurally removing of parts of the spin-coated sealing material such that the sealing structure 126 remains.

In another embodiment, the step of creating the elastic sealing structure is performed using a stamping technology, wherein the stamp is structured such that the sealing structure with a predefined lateral geometry is stamped onto the first surface 122 of the second metal layer 120.

The structuring of the first metal layer 110, the second metal layer 120 and in case of the embodiments according to FIGS. 2 and 3, of the other metal layers, to provide the cavities/recesses 115, the holes 125, 135, 235, 225, etc. can be performed using laser cutting, laser ablation or etching.

The bonding or mechanical connection of the metal layers can be performed using laser welding.

Summarizing the aforementioned discussion of the different embodiments, certain embodiments of the invention provide a valve that is solely built from metal layers or metal membranes and a sealing, for example, made of silicone. This type of valve construction has an essential cost advantage in comparison to material and production processes using silicon from which conventional micro valves are built. The embodiments comprise a silicone sealing in order to provide a hard/weak or hard/soft sealing. The individual layers of the valve are bonded using laser welding. Thus, a bonding-layer-less (i.e. a bonding without a bonding material, e.g. glue, between the metal layers to be connected), absolutely sealed and media inert construction of the micro check valve is provided. The use of especially thin layers of the soft, elastic material for improving the sealing effect and the combination of metal foils or metal layers with a silicone sealing provide facilitate improved sealing characteristics.

Further embodiments of the method for producing the micro check valve comprise pre-treating the plate structure or the spring elements with a laser to induce—through a targeted, thermal impact during the laser treatment—a pre-tensioning or pre-stiffening of the valve, respectively the spring elements, e.g. to improve the sealing characteristics and/or to adjust the threshold pressure difference at which the valves open.

The valve or sealing structure can be produced, for example, by directed or selective spraying of a silicone resist or by spin-coating and consecutive structured or selective removal of the silicone resist with an ultraviolet laser (UV laser). In further embodiments, the valve lips or the sealing structure (the sealing structure forms a valve lip) are produced by stamping.

Alternatively to the valve flap geometry shown in FIG. 1, a circular membrane or layer shape can also be used to facilitate a more exact definition of the bending and pre-tension of the valve.

The hard/soft sealing has the advantage that the sealing effect is improved with increasing pressure. Thus, it is possible to also provide absolutely leak-proof valves. Furthermore, embodiments of the valve are much more particle tolerant than hard/hard systems. In further embodiments, a further silicone layer can be generated on the valve's lower side to provide a soft/soft sealing.

For a mass production of embodiments of the micro check valve, the micro check valves can be provided arranged side-by-side on the metal foil or metal layer and built in parallel (batch-process). The structuring of the valve geometry can be performed using laser cutting or etching. The bonding of the metal foils or layers can be performed using laser welding. The sealing materials can be brought onto the metal layers or foils either before or after the structuring process of the metal layers. A selective removal of the sealing material is also possible via laser beams or selective etching.

The definition of the pump chamber is provided by mounting a pre-bulged membrane on a planar pump chamber floor. Thus, a high compression ratio can be achieved, as the valves show practically no dead volume.

Although based on FIGS. 1-3 embodiments of the valve made of metal foils have been described, similar considerations apply to embodiments based on foils or layers made of synthetic materials or other materials with equivalent properties or layer structures thereof.

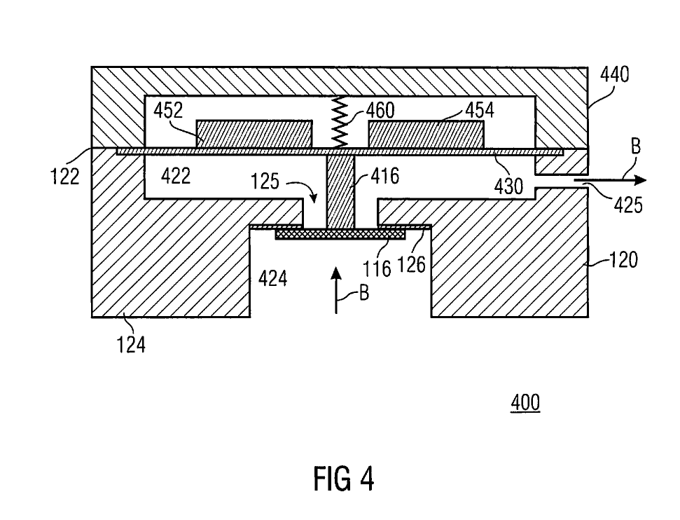

Based on FIGS. 1-3, embodiments of passive micro check valves and methods for producing same have been described. In the following, based on FIGS. 4-8, further embodiments of valves and micro pumps comprising such valves including methods of producing the same are described.

FIG. 4 shows a schematic cross sectional view of a normally closed active valve with the inventive soft sealing. The valve 400 of FIG. 4 comprises a valve base structure 120, the valve hole 125, the valve plate 116, a valve membrane 430, a valve cover 440 and two piezo drive means 452 and 454. The term “base structure” 120 is used as the term to describe the structure in which the valve opening 125 is formed and is a generic term comprising foils or layers 120 as described based on FIGS. 1-3, and valve bodies 120 as shown in FIG. 4 and the following figures. The base structure 120 comprises a first surface or side 122 and a second surface or side 124 arranged opposite to the first surface. The base structure 120 comprises a first cavity 422 on the first side 122 and a second cavity 424 on its second side 124 which are in fluid connection via the valve opening 125 in an open state of the valve. The valve membrane 430 is arranged in a deflectable manner between the first surface 122 of the base structure 120 and a surface of the valve cover facing towards the base structure at the border of the valve membrane 430. The valve cover 440 comprises a cavity facing towards the membrane and provides, for example, sufficient space to arrange the piezo drive means 452, 454 on a surface of the valve membrane 430 facing away from the base structure. The valve plate 116 is mechanically connected to the center of the valve membrane 430 via a pin 416 extending through the valve opening 125 and the recession 422. The base structure 120 further comprises a second valve opening 425 in fluid connection to the first valve opening via the recession 422. According to the fluid direction (see arrows B) in FIG. 4, the valve opening 125 forms the valve inlet and the second valve opening forms the valve outlet.

FIG. 4 shows the valve 400 in a non-actuated state, wherein the pump membrane has a planar shape and the valve plate 116 compresses the sealing structure 126 in compression direction to seal the valve opening 125 and the valve 400. As can be further seen from FIG. 4, the sealing structure 126 is arranged on a surface of the cavity 424, extends orthogonal to the compression direction and is arranged adjacent and surrounding the valve opening 125.

As can be seen from FIG. 4, in a non-actuated state the valve 400 is closed. In case the piezo drives 452 and 454 are activated, they bend the valve membrane 430 towards the valve opening 125 and, thus, open the valve 400.

The valve design according to FIG. 4 allows to provide very good sealing characteristics even at very high pressures like 30 bar because the pressure in fluid direction additionally presses the valve plate 116 against the sealing structure 126 and, thus, even further compresses the sealing structure 126. The spring element 460 (counter spring element) arranged in compression direction between the valve membrane 430 and the valve cover 440 is optional and can, for example, be adapted to support the piezo drive means 452 and 454 to open the valve even at very high pressures. The piezo drive means 452, 454 can be piezo ceramic elements, the valve membrane 430 can be a steel membrane, the base structure 120 be a steel base structure or valve body.

Valves as shown in FIG. 4 can be used, for example, for controlling the fluent connection of a reservoir connected to the first valve opening 125 and the combustion chamber connected to the valve via the second valve opening 425.

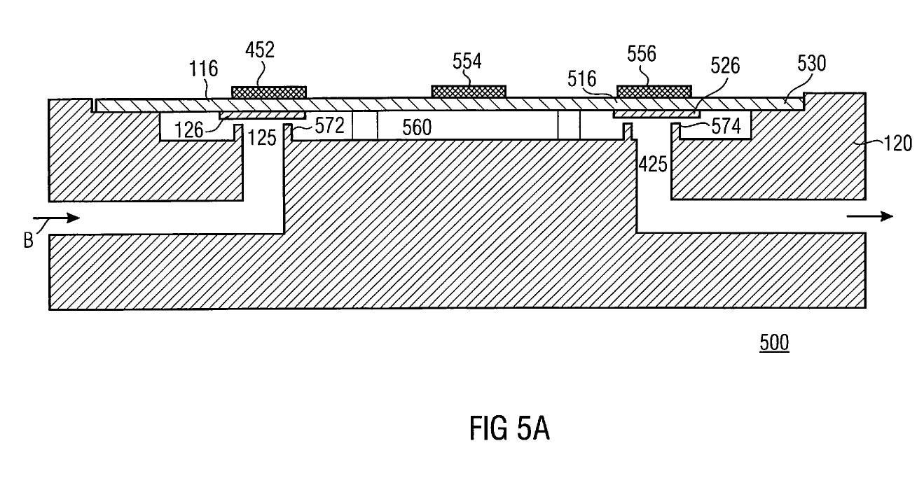

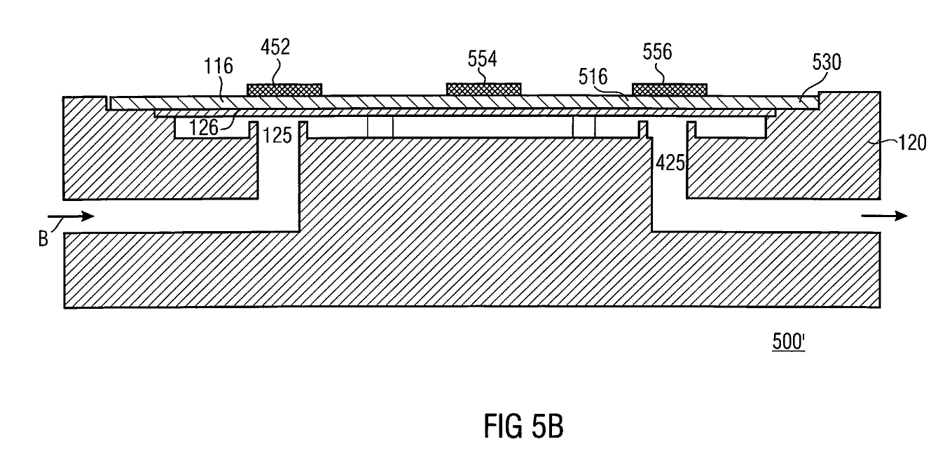

FIG. 5A shows a schematic drawing of a cross section of a micro peristaltic pump with soft sealing comprising a base structure 120, with a first valve opening 125 and a second valve opening 425 formed in the base structure 120, a first sealing structure 126, a second sealing structure 526, a pump membrane 530, and three piezo drive means 452, 454 and 456. The pump membrane 430 is connected to the base structure 120 so as to form a pump chamber 560 between them. The base structure 120 further comprises a valve seat or valve lips 572 formed as protrusions from the base structure 120 extending into the pump chamber and surrounding the first valve opening 125, and a second valve seat 574 or second valve lips 574 formed as protrusions from the base structure 120 extending in compression direction into the pump chamber and arranged around the second valve opening 425. As can be seen from FIG. 5A, the first valve of the micro peristaltic pump 500 is formed by the first valve plate 116, the first ceiling structure 126, the first valve opening 125 respectively the first valve seat 572 and the first piezo drive means 452 adapted to open and close the first valve. As can be seen from FIG. 5A, the first valve plate 116 is formed by a section of the pump membrane 530 arranged opposite through the valve opening 125. The first sealing structure 126 is arranged opposite to the first valve opening 125 on a surface of the pump membrane 530 facing towards the pump chamber 560. The first piezo drive means 452 is arranged opposite to the first sealing structure 126 on a surface opposed to and facing away from the first sealing structure 126. In a non-actuated state, the first valve is open. In case the piezo drive means 452 is actuated, the piezo drive means drives the valve plate 116, i.e. the section of the pump membrane 430 opposite to the valve opening 125, towards the valve opening 125 and compresses the sealing structure 126 to seal and close the first valve.

The second valve of the micro peristaltic pump is formed by the second opening 425 respectively the second valve seat 574, the second sealing structure 526, the valve plate 516 and the second piezo drive means 556. The same considerations concerning the arrangement and the function as for the first valve also apply to the second valve.

The third piezo drive means 554 is used to amend the pump chamber volume 560. By appropriate closing and opening actuations of the first, second and third piezo drive means, the micro pump 500 can pump fluids from left to right according to the orientation of FIG. 5A (see direction of arrows with reference sign B) or in the reverse direction, i.e. from right to left.

As can be seen from FIG. 5A, the micro pump 500 comprises two separate sealing structures 126, 526.

FIG. 5B shows a schematic cross section view of an alternative embodiment of the peristaltic micro pump 500′ similar to the one shown in FIG. 5A. In contrast to the embodiment in FIG. 5A, the micro pump 500′ comprises one contiguous sealing structure 126 forming the sealing structure of the first valve and the second valve.

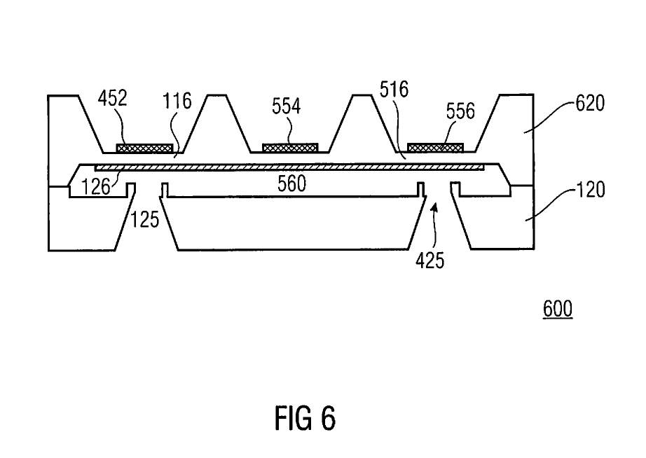

Referring to FIG. 6, the piezo drive means 452, 554 and 556 can, for example, be again piezo ceramic elements and the sealing structure 126, 526 can comprise silicon similar to the environment described based on FIG. 5B. The concept and the functioning is the same as described for FIG. 5, however, in case of FIG. 6 the base structure is a structured silicon chip and the pump membrane restrictively the valve plates 116 are formed by thinned sections of another silicon chip 620 arranged on top of the base structure 120 so as to form the pump chamber 560. The second silicon chip 620 comprises on a surface facing towards the first chip 120 or base structure 120 a contiguous sealing structure 126 for sealing the first valve, respectively first opening 125 and the second valve respectively second opening 425 by actuating the first piezo drive means 452 respectively the second piezo drive means 556. The second chip 620 can also be referred to as membrane element or membrane chip 620.

The sealing structure can, for example, be made of silicon. To protect the silicon sealing structure 126, the two silicon chips 120, 620 are, for example, bonded by low temperature bonding.

In an alternative embodiment, two separate sealing structures 126 and 526 as described based on FIG. 5A, can also be used instead of the one contiguous sealing structure 126. The peristaltic micro pump without the sealing structure 126 is, for example, described in US 2005/0123420 A1.

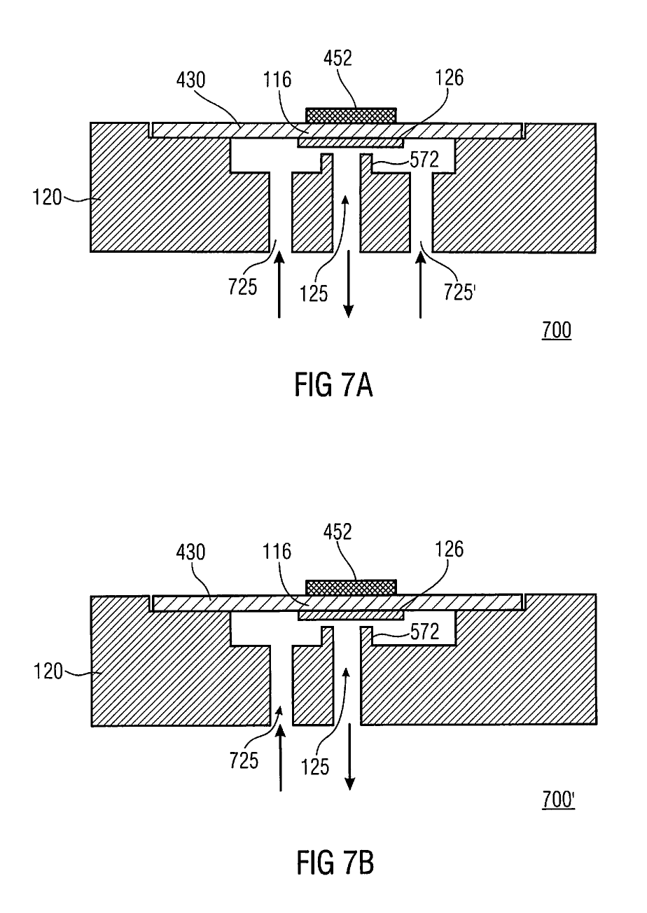

FIGS. 7A and 7B show two active normally open micro valves. The micro valve 700 according to FIG. 7A comprises a base structure 120, with a first valve opening 125, a second valve opening 725 and a third valve opening 725′ formed in the base structure 120, a valve membrane 430, a sealing structure 126, a piezo drive means 452 and the valve plate 116. A possible flow direction of the valve 700 in case of an open state is indicated by the straight arrows, wherein the first valve opening 125 forms an outlet valve opening and the second and third valve openings 725 and 725′ form valve inlet openings. The fluid connection between the first valve opening 125 and the other two valve openings is controlled by the piezo actuator 452. As can be seen from FIG. 7A, the valve plate 116 is formed as a section of the valve membrane 430 arranged opposite to the valve opening 125 respectively the valve seat 572. One might also say that the whole valve membrane 430 forms the valve plate 116. The sealing structure 126 is arranged on a surface of the valve plate 116 respectively valve membrane 430 opposite to the first valve opening 125 respectively facing towards the first valve opening 125. The piezo drive means 452 is arranged opposite to the sealing structure 126 on a surface of the valve plate 116 facing away from the first opening 125. The piezo drive means 452 is adapted to, when actuated, drive the valve plate 116 and the sealing structure 126 towards the valve opening 125 to close the valve.

FIG. 7B shows a similar embodiment of the valve as described based on FIG. 7A. In contrast to vale 700, valve 700′ comprises only one valve opening 725.

The base structure 120 can, for example, comprise synthetic materials and the membrane 430 may comprise or be made of stainless steel. The piezo drive means can, for example, be again a piezo ceramics.

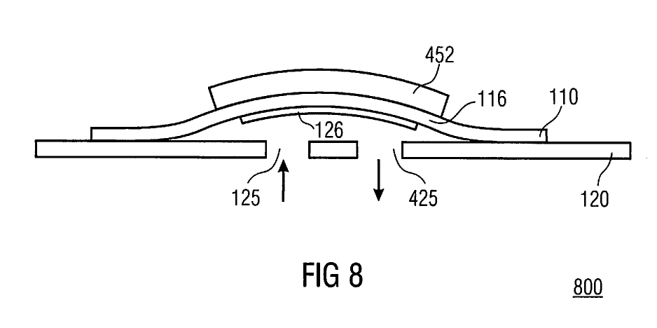

FIG. 8 shows a further embodiment 800 of a normally open active valve 800, comprising a base structure 120, for example, a foil or layer 120 with a first valve opening 125 and a second valve opening 425 formed within the base structure 120, a valve membrane formed by a further layer 110, the membrane forming at the same time the valve plate 116, a sealing structure 126 and a piezo drive means 452. The membrane 110 is pre-bulged, or in other words is bulged in case the piezo drive means 452 is not actuated. As can be seen from FIG. 8, the valve membrane 110 is arranged and connected to the base structure 120. Due to its pre-bulged shape the valve provides a fluid connection between the first valve opening 125 and the second valve opening 425 in a non-actuated state. The sealing structure 126 is arranged on a surface of the valve plate 116 respectively membrane 110 facing towards the first valve opening 125 and the second valve opening 425 and opposed to both. The piezo drive means 152 is arranged opposed to the sealing structure 126 on a surface of the valve plate 116 facing away from the valve openings. In case the piezo drive means 152 is actuated, the piezo drive means drives the membrane and the sealing structure 126 towards the first valve opening 125 and the second valve opening 425 to close and seal the valve by compressing the sealing structure 126. In alternative embodiments, the sealing structure 126 can be arranged to be only positioned opposite to the first valve opening 125 or the second valve opening 425 to, thus, only seal the first valve opening or the second valve opening.

Summarizing the afore mentioned description, embodiments of the valve comprise a valve opening 125 and a valve plate 116 arranged to seal the valve opening 125 in a close state by means of compressing a sealing structure 126 wherein the sealing structure has an uncompressed dimension hᵤ in a compression direction of less than 100 μm. In embodiments the uncompressed dimension hᵤ is less than 60 μm or less than 40 μm.

Furthermore, the valve plate 116 can be arranged within the valve membrane and is adapted to compress the sealing structure 126 by more than 10% to a compressed dimension in the compression direction in case no external pressure is applied to the valve in a close state. In embodiments the valve plate 116 compresses the sealing structure by more than 20% in case no external pressure is applied. As explained, the sealing structure may comprise a polymer, for example silicon, caoutchouc or polyterafluorethylen (PTFE) as sealing material. In certain embodiments the valve opening 125 is formed in a base structure 120, for example a valve body (see for example FIGS. 4 to 7) or a layer or foil (see FIGS. 1 to 3 and 8). In addition the valve plate can be formed in a further layer or foil connected to the base structure (see FIGS. 1 to 3 and 5 to 8). The layer the valve plate is formed in and the base structure may comprise metal, stainless steel or spring stainless steel, synthetic materials and/or semiconductor materials. Stoppers as described based on FIG. 1 can be incorporated in any of the aforementioned embodiments.

The sealing structure 126 can be arranged on a surface 114 of the valve plate 116 facing towards the valve opening 125 or on a surface 122 of the base structure 120 facing towards the valve plate. The valves may even comprise a further sealing structure arranged opposite to the sealing structure, wherein the valve plate is arranged to seal the valve by means of compressing the sealing structure and the further sealing structure such that in the closed state of the valve the sealing structure and the further sealing structure touch to seal the valve. Although in particular embodiments of active valves comprising piezo drive means have been described, further embodiments of the valves may comprise other drive means, for example electrostatic drive means, electromagnetic drive means, magnetorestrictive drive means.

The impermeability of sealings, in particular hard-hard sealings, is influenced by the roughness of the material of the valve plate and, for example the valve seat, and the unevenness of the same. In the following further explanations are provided with regard to the compressing of the sealing structure and the impermeability of the hard-soft sealing for metal foils. The roughness of the metal foil is, for example 1 μm (maximum roughness Rₘₐₓ). The Young's modulus of the sealing material is, for example 2.6 MPa for the silicon Sylgard 184. When diluting the silicon with a diluter, the silicon becomes weaker with an increasing proportion of the diluter. With a proportion of 10% of the diluter the Young's modulus of the silicon is reduced by approximately 23%. In case of a proportion of 20% of the diluter the Young's modulus of the silicon is reduced to 1.5 MPa. DESOL of the company Drewo (Toluol) is, for example, used as diluter.

The stiffness of the silicon sealing structure is referred to as D and is determined by the following equation:

$$D = \frac{EA}{L} = 88.0 e 3 \frac{N}{m}$$

with A being the contact surface, L being the height or the dimension in compression direction of the sealing structure and E the Youngs-modulus or E-module. The sealing structure is a sealing ring and has an outer diameter OD of 3 mm and an inner diameter ID of 1 mm. The uncompressed height of the sprayed silicon is, for example, 100 μm. Thus, the closing pressure p respectively the closing force is determined by:

$$F = {DR}_{max} = 88.0 mN$$

$$p = \frac{{DR}_{max}}{π {R}_{OD}^{2}} = 124 hPa$$

with D being the stiffness, Rmax being the maximum roughness and ROD being the radius of the outer diameter OD of the sealing ring. At this force respectively at this pressure the steel foil is sealed. However, the aforementioned is a worst case estimation. Typically it is not necessitated to push through the whole roughness to seal the valve. In other words the real pressure is noticeably lower, for example in case the average roughness is used. In this case the pressure is by the factor of 10 smaller.

For steel the unevenness is more important than the roughness. Unevenness of steel foils are, for example caused by plastic deformations, for example due to thermal inputs, or by asymmetric mechanical tensions.

For silicon valves the roughness of a polished valve plate is smaller than 1 nm. Therefore, the sealing of the roughness is typically no problem. The valve seals so to speak seals pressureless. The unevenness of silicon is less critical than for metal foils, as the plastic deformation typically does not occur.

Summarizing the aforementioned, the above mentioned soft sealings are very advantageous for silicon. In embodiments low temperature wafer bonding is used for bonding the two silicon chips. For steel foils or foils of other materials the soft sealings are also very advantageous. The necessitated uncompressed dimension in compression direction can be even further reduced in case the production methods and the design allow to reduce the unevenness of the metal foils or other foils.

As explained in the beginning, to seal the valve despite the roughness and the unevenness, the sealing structure is compressed by 10% of its uncompressed dimension.

For spraying the silicon Sylgard 184, the silicon necessitates a certain viscosity. The viscosity of Sylgard 184 is about 3.9 Pas, and thus, not sprayable. Therefore, the viscosity of the viscous silicon Sylgard 184 is reduced used by the diluter DESOL such that it becomes sprayable. Spraying is performed with a coating machine, wherein the medium or sealing material to be sprayed is led to a spraying head via a pressure pipe.

For the methods for producing using spin coating or stamping the sealing material is also diluted to facilitate sealing structures with uncompressed dimensions in the compressor direction of less than 100 μm, and in particular with less than 60 μm or less than 40 μm.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A valve, comprising:
a valve opening; and
a valve plate arranged to seal the valve opening in a closed state by means of compressing a sealing structure, wherein the sealing structure comprises an uncompressed dimension in a compression direction of less than 100 μm.

2. The valve of claim 1, wherein the uncompressed dimension is less than 60 μm or less than 40 μm.

3. The valve of claim 1, wherein the valve plate is adapted to compress the sealing structure by more than 10% to a compressed dimension in the compression direction in case no external pressure is applied to the valve in a closed state.

4. The valve of claim 1, wherein the sealing structure comprises a polymer as sealing material.

5. The valve of claim 4, wherein the sealing structure comprises silicon, caoutchouc or polyterafluorethylen (PTFE) as sealing material.

6. The valve of claim 1 wherein the valve plate is formed in a first layer and the valve opening is formed in a base structure and is arranged opposite to the valve plate.

7. The valve of claim 6, wherein the first layer and/or the base structure comprises metal, stainless or spring stainless steel.

8. The valve of claim 6, wherein the first layer and/or the base structure comprises a synthetic material or a semiconductor material.

9. The valve of claim 6, wherein the base structure is a second layer.

10. The valve of claim 6, wherein the sealing structure is arranged on a surface of the valve plate facing towards the valve opening or on a surface of the base structure facing towards the valve plate.

11. The valve of claim 1, wherein the valve comprises a further sealing structure arranged opposite to the sealing structure, wherein the valve plate is arranged to seal the valve by means of pressing the sealing structure towards the further sealing structure and is arranged to seal the valve by means of compressing the sealing structure and the further sealing structure.

12. The valve of claim 1, wherein the valve is flap valve or an orthoplanar valve.

13. The valve of claim 1, wherein the valve is a passive micro check valve.

14. The valve of claim 1, wherein the valve is an active valve comprising a driver adapted to move the valve plate between an open state and the closed state.

15. The valve of claim 14, wherein the valve is a micro valve and comprises a piezo driver as driver.

16. The valve of claim 14, wherein the valve is a normally closed valve and the driver is adapted to move the valve plate to an open state when the driver is actuated.

17. The valve of claim 13, wherein the valve is a normally open valve, and a driver is adapted to move the valve plate to a closed state when the driver is actuated.

18. The valve of claim 17, wherein the valve plate is formed by a pre-bulged valve membrane and the driver is adapted to move the valve membrane towards the valve opening such that the valve membrane closes the valve opening by means of compressing the sealing structure.

19. A micro pump comprising a first valve and/or a second valve, the valve comprising:
a valve opening; and
a valve plate arranged to seal the valve opening in a closed state by means of compressing a sealing structure, wherein the sealing structure comprises an uncompressed dimension in a compression direction of less than 100 μm.

20. The micro pump according to claim 19, the micro pump being a peristaltic micro pump comprising:
a pump body;
a pump membrane connected to the pump body so as to define a pump chamber of the peristaltic micro pump;
wherein the first valve is adapted to control a fluid connection between a first pump opening of the peristaltic micro pump and the pump chamber, and the second valve is adapted to control a fluid connection between the pump chamber and a second pump opening of the peristaltic micro pump.

21. The micro pump according to claim 19, wherein the sealing structure of the first valve and the sealing structure of the second valve are formed by one contiguous sealing structure.

22. A layer structure comprising a first layer arranged above a second layer and a first valve and a second valve, the valve comprising:
a valve opening; and
a valve plate arranged to seal the valve opening in a closed state by means of compressing a sealing structure, wherein the sealing structure comprises an uncompressed dimension in a compression direction of less than 100 μm,
wherein the valve plate of the first valve and the valve opening of the second micro valve are formed in the first layer and the valve opening of the first valve and the valve plate of the second valve are formed in the second layer.

23. A micro pump comprising:
a layer structure comprising a first layer arranged above a second layer and a first valve and a second valve, the valve comprising:
a valve opening; and
a valve plate arranged to seal the valve opening in a closed state by means of compressing a sealing structure, wherein the sealing structure comprises an uncompressed dimension in a compression direction of less than 100 μm,
wherein the valve plate of the first valve and the valve opening of the second micro valve are formed in the first layer and the valve opening of the first valve and the valve plate of the second valve are formed in the second layer;
a pump membrane connected to the first layer so as to define a pump chamber, wherein the pump membrane is pre-bulged; and
a driver adapted to move the pump membrane towards the first layer when the driver is activated.

24. A method of producing a valve, the valve comprising a valve opening and a valve plate arranged to seal the valve opening in a closed state by means of compressing a sealing structure, wherein the method comprises:
producing the sealing structure with an uncompressed dimension in a compression direction of less than 100 μm.

25. The method of claim 24, wherein the producing of the sealing structure is performed by spraying the sealing structure.

26. The method of claim 25, further comprising:
providing a mask defining a lateral geometry of the sealing structure; and
spraying an elastic sealing material using the mask to create the sealing structure in areas defined by the mask.

27. The method of claim 24, wherein producing the sealing structure comprises:
spin-coating an elastic sealing material onto a surface of the valve plate facing towards the valve hole or onto at least a part of a surface of the base structure facing towards the valve plate; and
removing predefined parts of the spin-coated elastic sealing material such that the sealing structure remains in a predetermined area of the surface of the valve plate or the base structure.

28. The method of claim 24, wherein producing the sealing structure is performed using a stamping technology.

29. The method according to claim 24, wherein the sealing structure comprises an elastic sealing material and the elastic sealing material is diluted so as to facilitate producing the sealing structure comprising an uncompressed dimension in a compression direction of less than 100 μm.
